(19) United States
(12) Patent Application Publication
(10) Pub. No.: US 2021/0339448 A1
(43) Pub. Date: Nov. 4, 2021

(54) Method for Predicting a Polymer's Pressure, Flow Rate, and Temperature Relationship While Flowing within an Injection Mold

(71) Applicant: Beaumont Technologies, Inc., Erie, PA (US)

(72) Inventors: John P. Beaumont, Harborcreek, PA (US); Benjamin Charles Ellis, Albion, PA (US)

(73) Assignee: Beaumont Technologies, Inc., Erie, PA (US)

(21) Appl. No.: 17/285,873

(22) PCT Filed: Oct. 16, 2019
(86) PCT No.: PCT/US2019/056601

§ 371 Date: Apr. 15, 2021

Related U.S. Application Data
(60) Provisional application No. 62/746,255, filed on Oct. 16, 2018.

(51) Int. Cl. B29C 45/77

(52) U.S. Cl. CPC B29C 45/77; B29C 2945/76006; B29C 2945/76274; B29C 2945/76859; B29C 2945/76545; B29C 2945/76752; B29C 2945/76381

(57) ABSTRACT

A method for predicting pressures in an injection molding system for molding plastic parts requires providing a mold that has at least one channel with each additional channel having a constant cross-sectional shape along its length and each channel having different thicknesses with a constant cross-sectional shape along its length. At least one first sensor configured to collect pressure data from each channel is provided. At least three second sensors configured to detect the presence of plastic located at known distances downstream of the at least one first sensor. Molten plastic is injected in each of the channels and sensor data is collected for the molten plastic flowing through each channel. A curve is fitted to progressive measured occurrences of pressure at the first sensor when plastic is first detected at each of the second sensors for each channel. Pressure can be predicted for a given flow rate, temperature, and channel thickness at, between, or beyond the measured occurrences.

### BACKGROUND

During the injection molding process, it is required that a polymer melt is injected into a mold's runner system, gates, and cavities using an injection molding machine. The ability of the molding machine to completely fill the mold with a given polymer is extremely complex and difficult to predict. If the polymer cannot fill the part forming cavities of a new mold, the required modification to the runner, gates, position of the gates, and the part forming cavities can be extremely costly and time consuming. Costs can easily be tens of thousands of dollars and proper mold filling and part formation can often take weeks, months, and even years. This challenge of filling a new mold is continually increasing with the continuous development of new polymers and demands of thinner walled plastic parts. Therefore, it is essential to be able to predict this relationship between the pressure to fill a mold, the flow rate of the polymer being injected into the mold, and temperature of the melt and mold.

### SUMMARY

What is presented is a method for predicting pressures in an injection molding system for molding plastic parts. A mold is provided that has at least one channel with each channel having a constant cross-sectional shape along its length and each additional channel having different thicknesses with a constant cross-sectional shape along its length. At least one first sensor is provided that is configured to collect pressure data from each channel. At least three second sensors are provided that are configured to detect the presence of plastic located at known distances downstream of the at least one first sensor. Molten plastic is injected in each of the channels and sensor data collected for the molten plastic flowing through each channel. A curve is fit to progressive measured occurrences of pressure at the first sensor when plastic is first detected at each of the second sensors for each channel. Pressures can be predicted for a given melt flow rate, melt temperature, and channel thickness at, between, or beyond the measured occurrences.

In variations of the method the molten plastic is injected at various melt temperatures, at various mold temperatures, or at various melt injection flow rates. In other variations of the method, the channels are of different thickness and the prediction is for the pressure for a channel at, between, or beyond a measured channel thickness. The at least one channel could also have varying cross-sectional shape along its length. The plastic in these various methods is a thermoset or a thermoplastic.

A mathematical model may be created based on data collected in the flow channels which may be fitted directly to the measured data or based on values calculated from the data collected in the flow channels, such as shear rate, shear stress or a molding viscosity. This mathematical model could be applied to a finite element mesh to predict plastic flow on three-dimensional geometries. The fitted curve and predictions could also be used to adjust the output of injection molding simulation software.

The at least one first sensor could be located upstream of each channel or in each channel. If the at least one first sensor is located in each channel, the first sensor could also act as the first of the at least three second sensors. In this instance the minimum number of sensors required to perform the method is three.

A method for predicting temperatures in an injection molding system for molding plastic parts is also presented. In this method, a mold is provided that has at least one channel with each channel having a constant cross-sectional shape along its length and each additional channel having different thicknesses with a constant cross-sectional shape along its length. A first sensor is provided that is configured to collect pressure data from each channel. A second sensor is provided for at least detecting the presence of plastic. The second sensor is located at a known distance downstream of the first sensor. At least one duplicate arrangement of the first sensor and the second sensor is provided at or beyond the second sensor. Molten plastic is injected at various temperatures in each of the channels and sensor data collected for the molten plastic flowing through each channel. The change in pressure between each progressive first and second sensor is calculated. The temperature change in each progressive first and second sensor section is derived based on the measured pressure change due to a known temperature change derived during the multiple temperature runs of injected molten plastic. Temperature rise or fall is predicted in a mold for a given melt material, melt temperature, channel thickness, and melt flow rate.

The plastic in this method may be a thermoset or a thermoplastic. In some variations of the method the duplicate arrangement uses the second sensor of the previous section as its first sensor. In other variations of the method the first and second sensor both collect pressure data.

The at least one first sensor could be located upstream of each channel or in in each channel. The at least one channel could have a varying cross-sectional shape along its length. The molten plastic could be provided at various mold temperatures or at various melt injection flow rates.

A mathematical model may be created based on the predicted temperature change. This mathematical model could be applied to a finite element mesh to predict melt temperature change during mold filling of three-dimensional geometries. The predicted temperature changes could also be used to adjust the output of injection molding simulation software.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a schematic showing a channel of an injection mold through which melted plastic flows and the layout of a series of sensors;

FIG. 2 is a graph showing a plot of measured data from a series of sensors along the length of a channel from the system shown in FIG. 1;

FIG. 3 is a graph showing measured data from FIG. 2 along with extrapolated data for longer channel lengths;

FIG. 4 is a schematic showing another channel of an injection mold through which melted plastic flows and the layout of a different series of sensors; and

FIG. 5 is a schematic showing another channel of an injection mold through which melted plastic flows and the layout of a different series of sensors.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

In 1978 the first commercial software programs to predict the flow of a polymer through a mold were introduced by Colin Austin through his company Moldflow Pty. Ltd. The challenge of these programs was that they first needed to model the viscosity of the melt which is affected by its temperature, pressure, and, as a non-Newtonian material, the influence of shear rate on the polymer melt. To determine temperature, the software had to calculate the simultaneously occurring heat gain by the viscous dissipation from the pressure driven flow of the melt as it flowed through the mold and the heat lost through conduction to the relatively cold mold. A further challenge was that the software needed to calculate the effect of the thickness of a growing frozen skin that will form as the molten polymer nearest the relatively cold mold channels is rapidly cooled. The polymer in nearest contact with the colder walls of the channel will solidify almost instantly. Laminates within the laminar flowing polymer that are further from the wall will progressively solidify as the melt continues to fill the mold. As this frozen skin progressively grows the cross section of the flow channel will continually decrease. Knowing the thickness of this skin is critical yet extremely difficult to try to calculate. The pressure required for a fluid flow in a closed channel, as found in the runners, gates, and cavities of an injection mold, can be described by Poiseuille's equation. For a round channel this equation can be expressed as:

$$Δ P = \frac{8 Q η L}{π {r}^{4}} \qquad Eq 1$$

Where ΔP is the pressure to flow through the channel; Q is the flow rate; η is the viscosity of the polymer and r is the radius of the flow channel. Note that r is to the fourth power, therefore, even the slightest error in predicting the thickness of the frozen layer will have a significant influence on the pressure predictions.

Prior art injection molding simulation software programs are still challenged in the same way as the earlier software programs. Though material characterization methods, viscosity models, and flow models have improved, they still take a very similar approach as the earliest programs to predict the relationship of pressure, flow rate, and temperature as plastic flows through a mold. The programs still attempt to predict the flow of a polymer melt through the melt delivery system (a mold's runner and gates) and part forming cavity, or cavities, of an injection mold through use of complex mathematical models of the polymers rheology, thermal properties, and phase change (fluid melt to solid). The methods presented herein attempt to capture the highly complex conditions where the non-Newtonian polymer melts properties are influenced by shear rate, temperature, and pressure, and polymer temperature is a result of the balance between heat lost to the relatively cold mold and heat gain through the viscous dissipation generated as the melt flows under high pressure through the mold. Further, current modeling methods must also account for the continually changing flow channel cross section as influenced by the thickness of a developing frozen layer that develops along the boundary of the mold's flow channel walls. As the thickness of the frozen skin increases, the flow channel's cross section decreases.

Today's start-of-the-art prior art modeling of the polymer melt's rheological characteristics is based on mathematically modeling the non-Newtonian rheological characteristics of a polymer melt flowing through a heated die, which is heated to a temperature of the molten polymer, thereby approximating an isothermal condition. This rheological characterization includes attempting to capture the influence of shear rate and temperature and sometimes pressure. The modeling of the rheological characteristics is combined with further measured polymer properties (which include physical and thermal properties) and the influence of temperature, temperature change, and the rate of temperature change on these properties. Additional polymer properties must be determined which can be used to capture the phase change where a polymer melt transitions to a highly viscous then solid phase polymer at the flow channel walls. The prediction of the thickness of this non-flowing polymer layer is critical as it dictates the actual flow channel cross section that the polymer melt is flowing through. The prediction of this thickness is highly complex as the temperature drop of the polymer nearest the channel wall can exceed 1,000° F./sec, resulting in a phase change of fluid to solid occurring at extremely fast rates that cannot be captured in most of the test methods used today to characterize the polymer for predicting flow in a mold. Polymer properties required for these prior art polymer flow simulation software programs typically include thermal conductivity, density (melt through solid phase), specific heat, specific volume as influenced by temperature and pressure, and each of these should include the influence of temperature. These measured properties are gathered for the purpose of mathematically modeling the thermal exchange between the relatively hot polymer and relatively cold mold and the development of the frozen layer along the flow channel boundaries.

To complete the objective to predict polymer flow in a mold, the prior art software programs must combine both the rheological and thermal modeling and phase change to predict the relationship of flow rate, pressure, and temperature of a polymer flowing through a mold.

What is presented is the prediction of the pressure, flow rate, and temperature relationship of a polymer melt flowing through a mold based primarily on the direct measurement of pressures, flow rate, and temperature relationships. These measurements may be captured directly in a mold that has multiple channels of various dimensions and cross-sectional shapes and sizes. It is preferred that each channel must be of constant cross-sectional shape along its length. Nevertheless, it is possible to get some useful pressure prediction information with channels of varying cross-section. This mold may be a specially designed apparatus developed to characterize the flow of a polymer through an injection mold, where the melt passes through a wide range of flow channel cross sections. The channels have a multitude of cross sections and with thermoplastic polymers are at a relatively cold temperature relative to the melt. With thermosetting polymers, the channels are normally at a relatively hot temperatures relative to the flowing fluid thermosetting polymers. The apparatus is the same or similar to that described in U.S. Pat. No. 9,097,565 (Method and Apparatus for Material Flow Characteristics, the “'565 patent”).

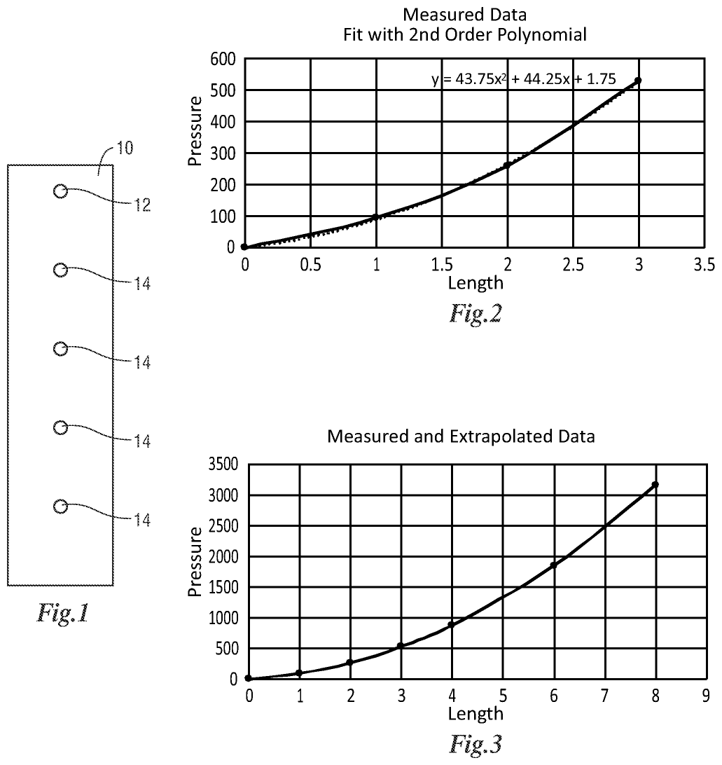

FIG. 1 shows a schematic of a channel 10 of an injection mold through which melted plastic flows when thermoplastic polymers are used or flowing thermosetting polymers in thermoset applications. This channel 10 could be in the specifically designed apparatus described above or a mold with channels of known dimensions, so long as at least one channel is provided. It is preferred that each channel has a constant cross-sectional shape along its length. Nevertheless, it is possible to get some useful pressure prediction information with channels of varying cross-section. Each other channel could have different thickness with a constant cross-sectional shape along its length.

At least one first sensor 12 is provided in that is configured to collect pressure data from each channel 10. The first sensor 12 could be located within the channel 10 as shown in the figure or it could be upstream of the channel 10, so long as the location of the first sensor 12 and the flow path between the first sensor 12 and the channel 10 is known. At least three second sensors 14 configured to detect the presence of plastic are located at known distances downstream of the at least one first sensor 12.

Melt temperatures are determined either within the channels or prior to entering the channels. The first sensor 12 may be any sensor that can detect the pressure of the melted plastic in the channel 10 or that the pressure can be derived from. The purpose of the second sensor 14 is to indicate when melted plastic reaches it so the second sensors 14 can be any sensor that will indicate that melted plastic has reached it. This could be any parameter such as temperature, pressure, etc. The second sensor 14 could detect the same scope of parameters as the first sensor 12, and if so, the second sensor 14 could collect the same data as the first sensor 12.

Molten plastic is injected in each of the multiple channels 10 and sensor data is collected for the molten plastic flowing through each channel. FIG. 2 illustrates a curve fit to progressive measured occurrences of pressure at the first sensor 12 when plastic is first detected at a progression of the second sensors 14 for each channel 10. In this sample there are four sensors, each 1 inch apart, and the pressure from the first sensor 12 is recorded when the melt is first detected at each sensor. As shown in FIG. 3, a sample equation derived for this fitted curve allows for predicting a pressure for a given flow rate, temperature, and channel thickness at, between, or beyond the measured occurrences. The equation shown is representative and not necessarily the optimum for prediction. The measurements could be carried out by injecting molten plastic at various temperatures which provides characteristics of molten plastic through the mold channels at these different temperatures or at temperature extrapolated from the multiple measured temperatures. The channels could also be varied to have different thicknesses and then the prediction is for extrapolating the melt characteristics for the pressure of a channel at, between, or beyond a measured channel thickness.

Essentially the method takes measurements along a flow path of constant cross-sectional area at a given flow rate, mold temperature, and melt temperature. It then extrapolates the pressure and can also determine a melt temperature change (increase, decrease, or no change). Then by taking measurements of melt injected at multiple flow rates, all these conditions can be extrapolated through changes in flow rate. If measurements are taken by flowing melt through additional channels each having different wall thicknesses, all these conditions can be extrapolated through changes in channel wall thickness as well. If measurements are taken by flowing melt at varying melt temperatures, all these conditions can also be extrapolated through change in melt temperature. If measurements are taken by flowing melt through channels with varying mold temperature, all these conditions can also be extrapolated through change in mold temperature.

If the first sensor 12 is located upstream of the channel 10, it is preferred that that the runner feeding the channel 10 is eliminated or the runner is a “hot runner”, or a machine nozzle is directly feeding the channel 10. This is to reduce or eliminate any cold regions between the first sensor 12 and the first second sensor 14 as cold regions in these spaces could allow the melt to solidify and would affect quality of data collected from the first sensor 12.

Locating the first sensor 12 within the channel 10 would reduce the minimum number of second sensors 14 that are required in that the first sensor 12 could double as a second sensor 14. In this configuration three data points could be obtained from a channel 10 to create a plotted curve. However, for better data collection, prediction, and extrapolation, more sensors are preferred. The disclosed method would apply whether the plastic is a thermoset or a thermoplastic. The channels 10 with thermoplastic polymers would be at a relatively cold temperature relative to the melt. With thermosetting polymers, the channels 10 would normally at a relatively hot temperatures relative to the flowing fluid thermosetting polymers.

The predictions are based on fitting curves, and extrapolations of fitted curves, fitted to data taken directly from the measured pressure and measured flow velocity through sections of known length and cross-sectional shape that are presented in units that can include pressure/length versus velocity for a given cavity wall thickness or cross section. The velocity measurements and predications can be represented by units of length/time or used to calculate flow rate and shear-rate (See Eq (2) below).

The prior art methods attempt to predict flow through a mold using highly complex rigorous mathematical solutions of heat transfer and non-Newtonian fluid flow based on measured material properties where most are measured in conditions very unlike those actually occurring in the mold. Rather what is presented herein is a significant simplification over the prior art in that it utilizes direct measurement of melt pressure and flow rate to predict flow. This new method bypasses the need to conduct complex thermal and flow calculations built on various mathematical models and material characterizations, including the thermal calculations (heat loss to the mold vs. heat gain from viscous dissipation) that are required to attempt to predict the polymers viscosity, and to attempt to predict the phase changes occurring as the laminates near the channel wall solidify.

This method of predicting the relationship of the pressure, flow rate, and temperature of a polymer melt flowing through a mold provides a simpler and more robust method than prior art approaches. As a result of its predictions being based on the direct measurements of a polymer as it flows through a mold, the method presented bypasses the need for much more complex material characterizations and the more complex computer-intense mathematical solutions of the prior art systems and methods. This new method provides a simpler, more robust, less expensive, more accurate solution than the prior art approaches. These benefits can combine to make accurate predictions more accessible and user friendly and thereby optimize opportunities and minimize risks to anyone involved in the design, development, or manufacture of injection molded plastic parts.

The captured temperature, flow rate, and pressure relationship of a melt flowing through a multitude of flow channel cross sections can be mathematically modelled to predict the temperature, flow rate, and pressure relationship of a melt flowing through a mold's melt delivery system and/or part forming cavities of an injection mold. Such mathematical models could also be applied to a finite element analysis (“FEA”) mesh to predict the temperature, flow rate, and pressure relationship of a melt and its influence on melt filling and plastic part formation. The directly measured data can also be used to extrapolate the temperature, flow rate, and pressure relationship of a melt flowing through a mold cavity having a geometry, temperature, and flow rate which may be the same or different from the directly measured conditions.

The directly measured temperature, flow rate, and pressure relationship of the melt, collected as described above, could be combined with additional polymer characterizations as described in the '565 patent, to provide further benefits in the prediction of flow and part formation within a FEA model of the part forming cavity and/or the melt delivery system used to deliver the melt to the part forming cavity.

The fitted curve and the predictions can also be used as parameters to adjust the output of traditional injection molding simulation software. This is done by first determining the errors in such software by contrasting their flow predictions of the various geometries and process conditions captured by the system described in the '565 patent for a given polymer melt, to the directly measured geometries and process conditions, then modifying one or more of the variables or mathematical models that the software uses to mathematically model the polymers flow through an injection mold such that the errors are minimized.

The predictions presented can be based on calculating the molding viscosity versus shear rate through the channels by measuring the melt temperature, flow rate, and pressure relationship of a melt flowing through the mold. The molding viscosity is calculated knowing the flow rate (Q), cross sectional shape, and pressure loss (ΔP) flowing through the molds cross sections. For a rectangular cavity-like flow channel having a width (w), height (h), and length (L), shear rate, shear stress, and viscosity are calculated as follows:

$$\begin{matrix}Shear Rate = \frac{6 Q}{{wh}^{2}} & Eq . 2 \\ Shear Stress = \frac{Δ Ph}{2 L} & Eq . 3 \\ Viscosity = Shear Rate \text{/} Shear Stress & Eq . 4\end{matrix}$$

As the above molding viscosity is determined in the measurement channels of a flow measurement apparatus developed to capture the melt temperature, flow rate, and pressure relationship of a melt flowing through a mold, the molding viscosity will include the influence of thermal exchange between the relatively hot flowing melt and the relatively cold mold including the thermal influences on viscosity and the development of a frozen skin along the flow channel walls.

A method of determining melt temperatures, increases or decreases, within the melt flowing through a mold channel is also presented. This method is based on first measuring the influence of changing melt temperature on the pressure of the melt flowing through a melt flow channel having a constant cross section. A mold having at least one channel with each channel having different dimensions or cross-sectional shape and size.

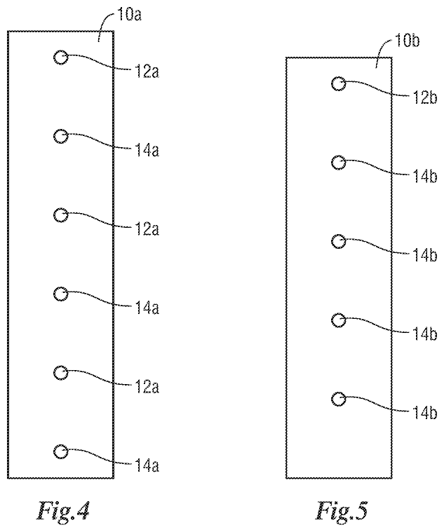

FIG. 4 shows a channel 10a used in this method. This channel 10a is of an injection mold through which melted plastic flows when thermoplastic polymers are used or for flowing thermosetting polymers in thermoset applications. This channel 10a could be in the specifically designed apparatus described in the '565 patent or a mold with channels of known dimensions, so long as at least one channel 10a is provided. It is preferred that each channel 10a has a constant cross-sectional shape along its length. Nevertheless, it is possible to get some useful pressure prediction information with channels of varying cross-section. Each other channel 10a could have different thicknesses with a constant cross-sectional shape along its length.

The melt enters each channel 10a at a given temperature and velocity, and the pressure drop through the channel 10a is measured. A first sensor 12a is provided that is configured to collect pressure data. A second sensor 14a is provided for at least detecting the presence of plastic. The second sensor 14a is located at a known distance downstream of the first sensor 12a. At least one duplicate arrangement of the first sensor 12a and the second sensor 14a is provided at or beyond the second sensor 14a. Injecting molten plastic is performed at various temperatures in each channel 10a. Sensor data is collected for the molten plastic flowing through each channel. The change in pressure between each progressive first sensor 12a and second sensor 14a is calculated. The temperature change is derived in each progressive first sensor 12a and second sensor 14a section based on the measured pressure change due to a known temperature change derived during the multiple temperature runs of injected molten plastic. This data can be used to predict temperature rise or fall in a mold for a given material, temperature, channel thickness, and flow rate. By extrapolating melt temperature and fill pressure from the measured data, melt pressure at any temperature between measured temperatures and within a reasonable range beyond the measured melt temperatures, can be estimated. Therefore, given a polymer melt flowing through a flow channel of constant cross section and a known length,

ΔMelt Temperature=ΔMelt pressure/Length. Eq. 5:

Then measuring the pressure of the melt flowing through a first portion of a flow channel having a constant cross section with the pressure flowing through a second section cross section and each portion having the same, or similar, length. The difference in pressure of the melt flowing through the first (P1) and second (P2) portions of the flow channel, being the pressure/length of each section (P1/Length and P2/Length). Melt temperature change occurring as a melt flows through a flow channel can then predicted by substituting in Eq. 5, knowing how much pressure changed with change in Melt temperature

P1/Length−P2/Length=ΔMelt temperature Eq. 6:

Note that the initial temperature prediction is not temperature, it is temperature change per length i.e. it is the temperature increase, decrease, or no change when the melt flows from the first pressure sensor 12a to the first second sensor 14a. Note that the melt pressure flowing between a set of sensors is compared to the pressure measured from the first sensor 12a of a set of sensors to the next first sensor 12a of a set of sensors. If these are the same pressures and the distance between sets of sensors is the same, then the melt flowing between a set of sensors did not change temperature. So, the only factor to be determined is the temperature change over the flow length between each set of sensors, i.e. temperature change per length (ΔT/Length).

Knowing this information, it is possible to extrapolate temperature rise over some flow length using a simple linear extrapolation. For example, if it is determined that there was a temperature rise of 7° F. over the 1-inch distance between the first set of first sensor 12a and second sensor 14a, then a simple linear extrapolation can be made and the temperature rise over 5 inches could be easily calculated as 5-inches×7° F.=35° F. With additional pressure sensors, additional data points could be collected, and a non-linear extrapolation could be performed with the example provided earlier in FIGS. 2 and 3 for pressure measurements.

Essentially the method takes measurements along a flow path of constant cross-sectional area at a given flow rate, mold temperature, and melt temperature. It then extrapolates the pressure and can also determine a melt temperature change (increase, decrease, or no change). Then by taking measurements of melt injected at multiple flow rates, all these conditions can be extrapolated through changes in flow rate. If measurements are taken by flowing melt through channels of varying wall thickness, all these conditions can be extrapolated through change in channel wall thickness as well. If measurements are taken by flowing melt at varying melt temperatures, all these conditions can be extrapolated through change in melt temperature. If measurements are taken by flowing melt through channels with varying mold temperature, all these conditions can be extrapolated through change in mold temperature.

The method presented above is equally applicable if the plastic is a thermoplastic or a thermosetting polymer. The channels 10a with thermoplastic polymers would be at a relatively cold temperature relative to the melt. With thermosetting polymers, the channels 10a would normally at a relatively hot temperatures relative to the flowing fluid thermosetting polymers.

Such mathematical models could also be applied to a finite element analysis (“FEA”) mesh and could also be combined with additional polymer characterizations as described in the '565 patent, to provide further benefits in the prediction of flow and part formation within a FEA model of the part forming cavity and/or the melt delivery system used to deliver the melt to the part forming cavity.

These predictions can also be used as parameters to adjust the output of traditional injection molding simulation software. This is done by first determining the errors in such software by contrasting their flow predictions of the various geometries and process conditions captured by the system described in the '565 patent for a given polymer melt, to the directly measured geometries and process conditions, then modifying one or more of the variables or mathematical models that the software uses to mathematically model the polymers flow through an injection mold such that the errors are minimized.

FIG. 5 shows a variation of channel 10b with first sensor 12b provided that is configured to collect pressure data. The second sensor 14b is also configured to collect pressure data. The second sensor 14b is located at a known distance downstream of the first sensor 12b. In this embodiment, the at least one duplicate arrangement of the first sensor 12a and the second sensor 14b uses the second sensor 14b of the previous section as its first sensor. In this embodiment every sensor in the channel measures pressure.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A method for predicting pressures in an injection molding system for molding plastic parts comprising:
providing a mold that has at least one channel with each channel having a constant cross-sectional shape along its length and each additional channel having different thicknesses with a constant cross-sectional shape along its length;
providing at least one first sensor configured to collect pressure data from each channel;
providing at least three second sensors configured to detect the presence of plastic located at known distances downstream of the at least one first sensor;
injecting molten plastic in each of the channels and collecting sensor data for the molten plastic flowing through each channel;
fitting a curve to progressive measured occurrences of pressure at the first sensor when plastic is first detected at each of the second sensors for each channel; and
predicting a pressure for a given melt flow rate, melt temperature, and channel thickness at, between, or beyond the measured occurrences.

2. The method of claim 1 wherein the injecting molten plastic is provided at various melt temperatures.

3. The method of claim 1 wherein the injecting molten plastic is provided at various mold temperatures.

4. The method of claim 1 wherein the injecting molten plastic is provided at various melt injection flow rates.

5. The method of claim 1 where the channels are of different thickness and the prediction is for the pressure for a channel at, between, or beyond a measured channel thickness.

6. The method of claim 1 wherein the plastic is a thermoset or a thermoplastic.

7. The method of claim 1 further comprising creating a mathematical model based on the fitted curve.

8. The method of claim 1 further comprising creating a mathematical model based on the fitted curve and applying the mathematical model to a finite element mesh to predict plastic flow on three-dimensional geometries.

9. The method of claim 1 further comprising using the fitted curve and predictions to adjust the output of injection molding simulation software.

10. The method of claim 1 wherein at least one first sensor is located upstream of each channel.

11. The method of claim 1 wherein at least one first sensor is located in each channel.

12. The method of claim 1 wherein at least one first sensor is located in each channel and the first sensor also acts as the first of the at least three second sensors.

13. The method of claim 1 wherein at least one channel has a varying cross-sectional shape along its length.

14. A method for predicting temperatures in an injection molding system for molding plastic parts comprising:
providing a mold that has at least one channel with each channel having a constant cross-sectional shape along its length and each additional channel having different thicknesses with a constant cross-sectional shape along its length;
providing a first sensor configured to collect pressure data from each channel;
providing a second sensor for at least detecting the presence of plastic, the second sensor located at a known distance downstream of the first sensor;
providing at least one duplicate arrangement of the first sensor and the second sensor at or beyond the second sensor;
injecting molten plastic at various temperatures in each of the channels and collecting sensor data for the molten plastic flowing through each channel;
calculating the change in pressure between each progressive first and second sensor;
deriving the temperature change in each progressive first and second sensor section based on the measured pressure change due to a known temperature change derived during the multiple temperature runs of injected molten plastic; and
predicting temperature rise or fall in a mold for a given melt material, melt temperature, channel thickness, and melt flow rate.

15. The method of claim 14 wherein the plastic is a thermoset or a thermoplastic.

16. The method of claim 14 wherein the duplicate arrangement uses the second sensor of the previous section as its first sensor.

17. The method of claim 14 wherein the first and second sensor both collect pressure data.

18. The method of claim 14 further comprising creating a mathematical model based on the predicted temperature change.

19. The method of claim 14 further comprising creating a mathematical model based on the predicted temperature change and applying the mathematical model to a finite element mesh to predict temperature change during mold filling of three-dimensional geometries.

20. The method of claim 14 further comprising using the predicted temperature changes to adjust the output of injection molding simulation software.

21. The method of claim 14 wherein at least one first sensor is located upstream of each channel.

22. The method of claim 14 wherein at least one first sensor is located in each channel.

23. The method of claim 14 wherein at least one channel has a varying cross-sectional shape along its length.

24. The method of claim 14 wherein the injecting molten plastic is provided at various mold temperatures.

25. The method of claim 14 wherein the injecting molten plastic is provided at various melt injection flow rates.
